(19) United States
(12) Patent Application Publication
(10) Pub. No.: US 2012/0176858 A1
(43) Pub. Date: Jul. 12, 2012

(54) Co-extruded marine sensor cable jacket with anti-fouling properties

(75) Inventors: Andre Stenzel, Sugar Land, TX (US); Bruce William Harrick, Sugar Land, TX (US)

(73) Assignee: PGS Geophysical AS

(21) Appl. No.: 12/930,587

(22) Filed: Jan. 11, 2011

(51) Int. Cl. G01V 1/38; B05D 7/20

(52) U.S. Cl. 367/20; 427/117

(57) ABSTRACT

A marine sensor cable comprises a jacket covering an exterior of the sensor cable, wherein the jacket comprises an outer portion containing biocide disposed in a co-extrusion process. A method for producing a marine sensor cable jacket comprises providing a co-extruder to construct a polyurethane jacket for a sensor cable with a first extruder constructing an inner portion of the jacket and a second extruder constructing an outer portion of the jacket; producing a mixture of thermo polyurethane and biocide; supplying thermo polyurethane to the first extruder; supplying the mixture of thermo polyurethane and biocide to the second extruder; and constructing the polyurethane jacket with the outer portion containing the biocide.

### CROSS-REFERENCES TO RELATED APPLICATIONS

Not Applicable

### FEDERALLY SPONSORED RESEARCH OR DEVELOPMENT

Not Applicable

### SEQUENCE LISTING, TABLE, OR COMPUTER LISTING

Not Applicable

### BACKGROUND OF THE INVENTION

1. Field of the Invention

This invention relates generally to the field of geophysical prospecting. More particularly, the invention relates to the field of marine sensor cables for marine geophysical surveys.

2. Description of the Related Art

In the oil and gas industry, geophysical prospecting is commonly used to aid in the search for and evaluation of subterranean formations. Geophysical prospecting techniques yield knowledge of the subsurface structure of the earth, which is useful for finding and extracting valuable mineral resources, particularly hydrocarbon deposits such as oil and natural gas. A well-known technique of geophysical prospecting is a seismic survey.

Marine geophysical surveying, such as seismic surveying, is typically performed using sensor cables, such as “streamers” towed near the surface of a body of water or an “ocean bottom cable” disposed on the water bottom. A streamer is in the most general sense a cable towed by a vessel. The sensor cable has a plurality of sensors disposed thereon at spaced apart locations along the length of the cable. In the case of marine seismic surveying the sensors are typically hydrophones, but can also be any type of sensor that is responsive to the pressure in the water, or in changes therein with respect to time or may be any type of particle motion sensor, such as a velocity sensor or an acceleration sensor, known in the art. Irrespective of the type of such sensors, the sensors typically generate an electrical or optical signal that is related to the parameter being measured by the sensors. The electrical or optical signals are conducted along electrical conductors or optical fibers carried by the streamer to a recording system. The recording system is typically disposed on the vessel, but may be disposed elsewhere.

In a typical marine seismic survey, a seismic energy source is actuated at selected times, and a record, with respect to time, of the signals detected by the one or more sensors is made in the recording system. The recorded signals are later used for interpretation to infer structure of, fluid content of, or composition of rock formations in the earth's subsurface. Structure, fluid content and mineral composition are typically inferred from characteristics of seismic energy that is reflected from subsurface acoustic impedance boundaries. One important aspect of interpretation is identifying those portions of the recorded signals that represent reflected seismic energy and those portions which represent noise.

Another technique of geophysical prospecting is an electromagnetic survey. Electromagnetic sources and receivers include electric sources and receivers (often grounded electrodes or dipoles) and magnetic sources and receivers (often wire multi-loop). The electric and magnetic receivers can include multi-component receivers to detect horizontal and vertical electric signal components and horizontal and vertical magnetic signal components. In some electromagnetic surveys, the sources and receivers are towed through the water, possibly along with other equipment, while in other surveys the receivers may be positioned on the ocean bottom.

Unfortunately, marine organisms adhere to and then grow on nearly everything that is placed in water for significant periods of time, including towed or ocean bottom geophysical equipment. Marine growth is often pictured in terms of barnacles, but also includes the growth of mussels, oysters, algae, bacteria, tubeworms, slime, and other marine organisms.

Marine growth results in lost production time required to clean the geophysical equipment. In addition, marine growth speeds corrosion, requiring quicker replacement of equipment, and increases drag resistance, leading to increased fuel costs. Thus, the elimination, or the reduction, of marine growth will have a major beneficial effect on the cost of marine geophysical surveying. Hence, marine growth presents a significant problem for a geophysical vessel operation due to downtime caused by a need for its removal, equipment damage, reduced seismic data quality due to increased noise, increased fuel consumption, and exposure of the crew to dangers associated with a streamer cleaning operations.

Thus, a need exists for a system and a method for protecting geophysical equipment in marine geophysical surveys, especially sensor cables, from marine growth.

### BRIEF SUMMARY OF THE INVENTION

In one embodiment, the invention is a marine sensor cable. The marine sensor cable comprises a jacket covering an exterior of the streamer, wherein the jacket comprises an outer portion containing biocide disposed in a co-extrusion process.

In another embodiment, the invention is a method for producing a marine sensor cable jacket with anti-fouling properties. The method comprises providing a co-extruder to construct a polyurethane jacket for a sensor cable with a first extruder constructing an inner portion of the jacket and a second extruder constructing an outer portion of the jacket; producing a mixture of thermo polyurethane and biocide; supplying thermo polyurethane to the first extruder; supplying the mixture of thermo polyurethane and biocide to the second extruder; and constructing the polyurethane jacket with the outer portion containing the biocide.

### BRIEF DESCRIPTION OF THE DRAWINGS

The invention and its advantages may be more easily understood by reference to the following detailed description and the attached drawings, in which:

FIG. 1 shows typical marine data acquisition using a sensor cable according to one example of the invention;

FIG. 2 shows a cut away view of one embodiment of a sensor cable segment according to the invention;

FIG. 3 shows a sensor cable jacket with an outer portion containing biocide that can be used in some examples; and

FIG. 4 is a flowchart showing an embodiment of the method of the invention for producing a marine sensor cable jacket with anti-fouling properties.

While the invention will be described in connection with its preferred embodiments, it will be understood that the invention is not limited to these. On the contrary, the invention is intended to cover all alternatives, modifications, and equivalents that may be included within the scope of the invention, as defined by the appended claims.

### DETAILED DESCRIPTION OF THE INVENTION

Marine growth is a problem for anything that is submerged in or moves through sea water for significant periods of time, including marine geophysical equipment. Thus, it is desirable to affix materials with biocide properties (“biocides”) to the surfaces of marine geophysical equipment. In particular, it is well-known in the art that copper has anti-fouling properties against marine growth when submerged in sea water.

The invention is a system and a method for protecting marine geophysical equipment from marine growth. The following discussion of the invention will be illustrated in terms of surface jackets of sensor cables, but this is not a limitation of the invention. Any form of geophysical equipment that can be and is disposed in a body of water, is vulnerable to marine growth, and has a polyurethane-based outer covering is considered appropriate for application of the present invention. For example, the invention can be applied to lead-ins covered with polyurethane-based materials.

Further, any form of geophysical equipment that can be and is disposed in a body of water, is used in electromagnetic (including natural source magnetotelluric) prospecting, and has a polyurethane-based outer covering, is also appropriate for application of the present invention. For example, the invention can be applied to sensor cables carrying electromagnetic receivers.

In one embodiment, the invention is a system and method for application of a coating comprising a biocide to surfaces of geophysical equipment components covered by polyurethane-based materials. The biocide coating will greatly reduce or perhaps even eliminate problems associated with marine growth.

One embodiment of the invention is applicable to manufacturing surface jackets for sensor cables. This embodiment is a co-extrusion process in which biocide is mixed into an outer layer of the surface jacket. This method ensures long anti-fouling effectiveness, since as the biocide residing in the outer layer erodes along with the wear-and-tear of the polyurethane base material, new biocide become exposed and effective.

In one particular embodiment, the biocide comprises particles of copper or particles of an alloy containing a significant amount of copper. Copper alloys include, but are not limited to, brass, copper oxide, copper thiocyanate, copper bronze, copper napthenate, copper resinate, copper nickel, and copper sulfide.

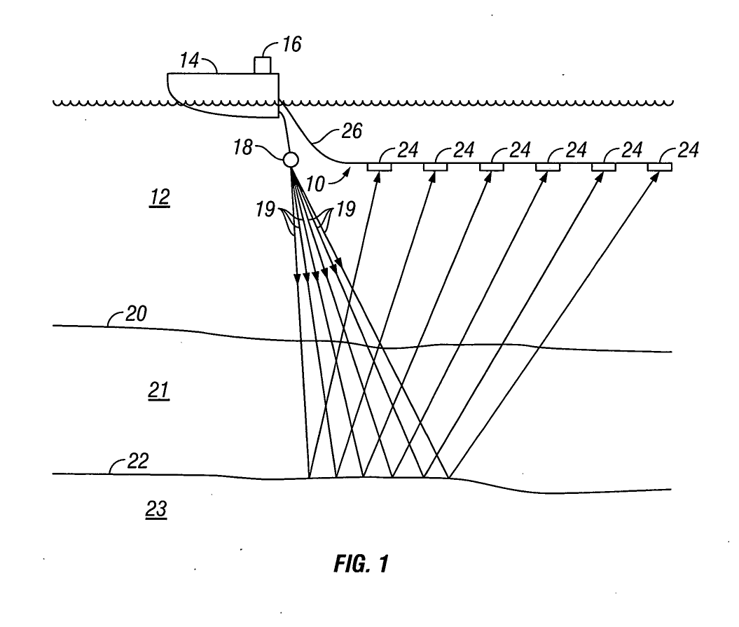

FIG. 1 shows an example marine seismic data acquisition system as it is typically used for acquiring seismic data. As discussed above, the invention is not limited to towed seismic streamers, which are only employed here for illustrative purposes. A seismic vessel 14 moves along the surface of a body of water 12 such as a lake or the ocean. The marine seismic survey is intended to detect and record seismic signals related to structure and composition of various subsurface earth formations 21, 23 below the water bottom 20. The seismic vessel 14 includes source actuation, data recording and navigation equipment, shown generally at 16, referred to for convenience as a “recording system”. The seismic vessel 14, or a different vessel (not shown), can tow one or more seismic energy sources 18, or arrays of such sources in the water 12. The seismic vessel 14 or a different vessel tows at least one seismic sensor cable 10 near the surface of the water 12. The sensor cable 10 is coupled to the vessel 14 by a lead-in cable 26. A plurality of sensor elements 24, or arrays of such sensor elements, are disposed at spaced apart locations along the sensor cable 10. The sensor elements 24, are formed by mounting a seismic sensor inside a sensor spacer.

During operation, certain equipment (not shown separately) in the recording system 16 causes the source 18 to actuate at selected times. When actuated, the source 18 produces seismic energy 19 that emanates generally outwardly from the source 18. The energy 19 travels downwardly, through the water 12, and passes, at least in part, through the water bottom 20 into the formations 21, 23 below. Seismic energy 19 is at least partially reflected from one or more acoustic impedance boundaries 22 below the water bottom 20, and travels upwardly whereupon it may be detected by the sensors in each sensor element 24. Structure of the formations 21, 23, among other properties of the earth's subsurface, can be inferred by travel time of the energy 19 and by characteristics of the detected energy such as its amplitude and phase.

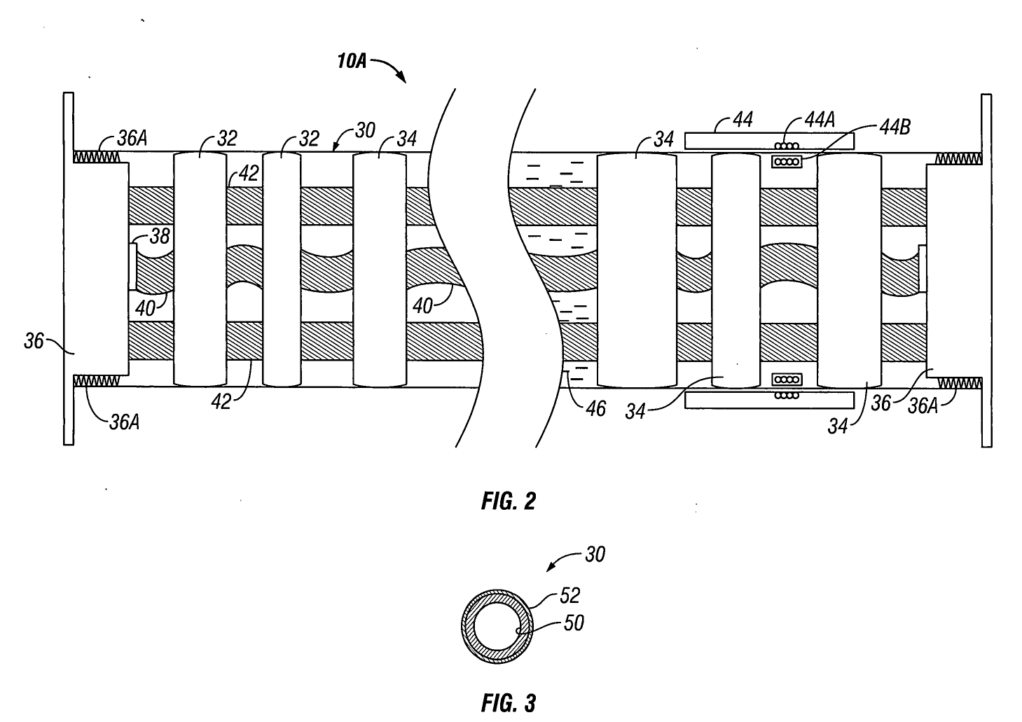

Having explained the general method of operation of a marine seismic sensor cable, an example embodiment of a sensor cable according to the invention will be explained with reference to FIG. 2, which is a cut away view of a portion (segment) 10A of a typical marine seismic sensor cable (10 in FIG. 1). A sensor cable as shown in FIG. 1 may extend behind the seismic vessel (14 in FIG. 1) for several kilometers, and is typically made from a plurality of sensor cable segments 10A as shown in FIG. 2 connected end to end behind the vessel (14 in FIG. 1).

The sensor cable segment 10A in the present embodiment may be about 75 meters overall length. A sensor cable such as shown at 10 in FIG. 1 thus may be formed by connecting a selected number of such segments 10A end to end. The segment 10A includes a jacket 30, which in the present embodiment can be made from 3.5 mm thick polyurethane and has a nominal external diameter of about 62 millimeters. The jacket 30 will be explained in more detail below with reference to FIG. 3. In each segment 10A, each axial end of the jacket 30 may be terminated by a coupling/termination plate 36. The coupling/termination block 36 may include ribs or similar elements 36A on an external surface of the coupling/termination plate 36 that is inserted into the end of the jacket 30, so as to seal against the inner surface of the jacket 30 and to grip the coupling/termination plate 36 to the jacket 30 when the jacket 30 is secured by and external clamp (not shown). In the present embodiment, two strength members 42 are coupled to the interior of each coupling/termination plate 36 and extend the length of the segment 10A. In a particular implementation of the invention, the strength members 42 may be made from a fiber rope made from a fiber sold under the trademark VECTRAN, which is a registered trademark of Hoechst Celanese Corp., New York, N.Y. The strength members 42 transmit axial load along the length of the segment 10A. When one segment 10A is coupled end to end to another such segment (not shown), the mating coupling/termination plates 36 are coupled together using any suitable connector, so that the axial force is transmitted through the coupling/termination blocks 36 from the strength members 42 in one segment 10A to the strength member in the adjoining segment.

The segment 10A can include a selected number of buoyancy spacers 32 disposed in the jacket 30 and coupled to the strength members 42 at spaced apart locations along their length. The buoyancy spacers 32 may be made, for example, from foamed polyurethane or other suitable material. The buoyancy spacers 32 have a density selected to provide the segment 10A with a selected overall density, preferably approximately the same overall density as the water (12 in FIG. 1), so that the sensor cable (10 in FIG. 1) will be substantially neutrally buoyant in the water (12 in FIG. 1). As a practical matter, the buoyancy spacers 32 provide the segment 10A with an overall density very slightly less than that of fresh water.

The segment 10A includes a generally centrally located conductor cable 40 which can include a plurality of insulated electrical conductors (not shown separately), and may include one or more optical fibers (not shown). The cable 40 conducts electrical and/or optical signals from the sensors (not shown) to the recording system (16 in FIG. 1). The cable 40 may in some implementations also carry electrical power to various signal processing circuits (not shown separately) disposed in one or more segments 10A, or disposed elsewhere along the sensor cable (10 in FIG. 1). The length of the conductor cable 40 within a cable segment 10A is generally longer than the axial length of the segment 10A under the largest expected axial stress on the segment 10A, so that the electrical conductors and optical fibers in the cable 40 will not experience any substantial axial stress when the sensor cable 10 is towed through the water by a vessel. The conductors and optical fibers may be terminated in a connector 38 disposed in each coupling/termination plate 36 so that when the segments 10A are connected end to end, corresponding electrical and/or optical connections may be made between the electrical conductors and optical fibers in the conductor cable 40 in adjoining segments 10A.

Sensors, which in the present example may be hydrophones, can be disposed inside sensor spacers, shown in FIG. 2 generally at 34. The hydrophones in the present embodiment can be of a type known to those of ordinary skill in the art, including but not limited to those sold under model number T-2BX by Teledyne Geophysical Instruments, Houston, Tex. In the present embodiment, each segment 10A may include 96 such hydrophones, disposed in arrays of sixteen individual hydrophones connected in electrical series. In a particular implementation of the invention, there are thus six such arrays, spaced apart from each other at about 12.5 meters. The spacing between individual hydrophones in each array should be selected so that the axial span of the array is at most equal to about one half the wavelength of the highest frequency seismic energy intended to be detected by the sensor cable (10 in FIG. 1). It should be clearly understood that the types of sensors used, the electrical and/or optical connections used, the number of such sensors, and the spacing between such sensors are only used to illustrate one particular embodiment of the invention, and are not intended to limit the scope of this invention. In other embodiments, the sensors may be particle motion sensors such as geophones or accelerometers.

At selected positions along the sensor cable (10 in FIG. 1) a compass bird 44 may be affixed to the outer surface of the jacket 30. The compass bird 44 includes a directional sensor (not shown separately) for determining the geographic orientation of the segment 10A at the location of the compass bird 44. The compass bird 44 may include an electromagnetic signal transducer 44A for communicating signals to a corresponding transducer 44B inside the jacket 30 for communication along the conductor cable 40 to the recording system (16 in FIG. 1). Measurements of direction are used, as is known in the art, to infer the position of the various sensors in the segment 10A, and thus along the entire length of the sensor cable (10 in FIG. 1). Typically, a compass bird will be affixed to the sensor cable (10 in FIG. 1) about every 300 meters (every four segments 10A).

In the present embodiment, the interior space of the jacket 30 may be filled with a gel-like material 46 such as a curable, synthetic urethane-based polymer. The gel-like material 46 serves to exclude fluid (water) from the interior of the jacket 30, to electrically insulate the various components inside the jacket 30, to add buoyancy to a sensor cable section and to transmit seismic energy freely through the jacket 30 to the sensors 34.

An example sensor cable jacket made according to the invention is shown in a schematic cross section (not necessarily to scale) in FIG. 3. The jacket 30 may include an outer portion 52 and a remaining inner portion 50. The jacket 30 may be made from polyurethane, including both portions 50, 52. Sensor cable jackets made of polyurethane are well-known in the art.

The outer portion 52 is also polyurethane, in which biocide is mixed at a desired ratio of biocide to thermal polyurethane to create the protective outer portion 52 of the sensor cable jacket 30. Thermal polyurethane is a raw grain-like material that is fed into an extruder to manufacture a tubular polyurethane sensor cable jacket. In one embodiment, the biocide is copper or copper alloy particles and the desired ratio comprises 10% to 40% copper or copper alloy in the mixture of copper or copper alloy with thermo polyurethane. One example of a method for producing such a jacket with the biocide, such as copper or copper alloy particles, disposed in an outer portion 52 of the jacket 30 is co-extrusion.

Extrusion is typically a process in which thermoplastic material is fed into a barrel and moved along by a rotating screw towards a die. The material is gradually melted as it moves down the barrel, either from friction or heaters. The melted material is forced through the die into a desired shape and then cooled. Co-extrusion is the process of extruding multiple layers of material simultaneously. Co-extrusion extrudes two or more materials through a single die from separate extruders arranged so that the extruded materials merge and weld together into a laminar structure before cooling.

This co-extrusion process produces a continuous polyurethane jacket 30, without layers, but with the biocide embedded in the outer portion 52 of the jacket 30. In one embodiment, the outer portion 52 comprises approximately 10% of a thickness of the jacket 30. This method ensures long anti-fouling effectiveness, since as the biocide residing in the outer portion 52 erodes along with the wear-and-tear of the polyurethane base material, new biocide become exposed and effective. In another embodiment, the biocide comprises a combination of copper or copper alloy particles and other biocide materials.

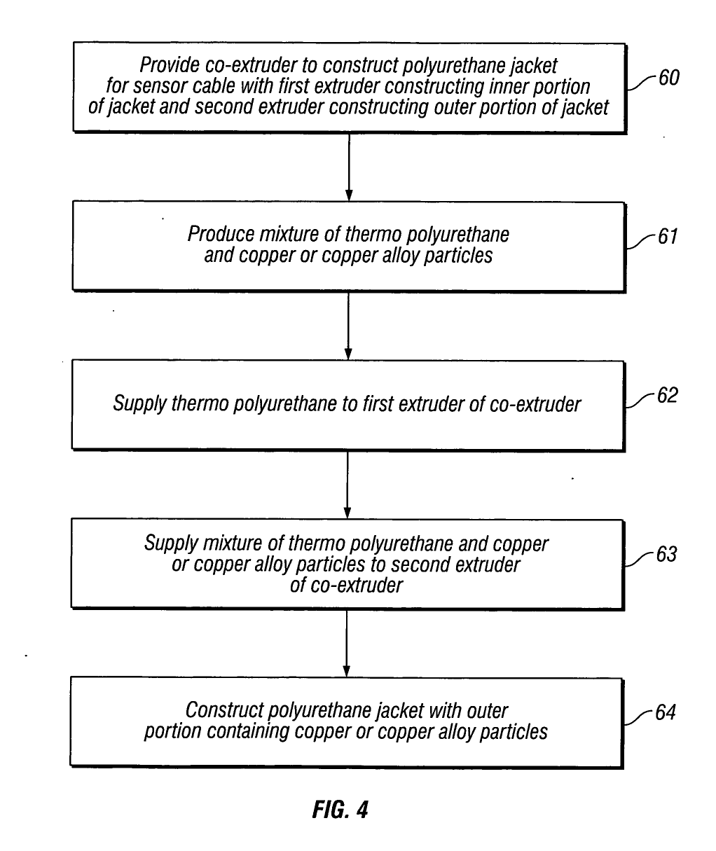

FIG. 4 is a flowchart showing an embodiment of the method of the invention for producing a marine sensor cable jacket with anti-fouling properties. The invention is here illustrated with the embodiment utilizing copper or copper alloy particles as the biocide. This is not intended to limit the invention, in which other materials that have biocide qualities can be employed or included with the copper or copper alloys.

At block 60, a co-extruder is provided to construct a polyurethane jacket for a sensor cable with a first extruder constructing an inner portion of the jacket and a second extruder constructing an outer portion of the jacket.

At block 61, a mixture of thermo polyurethane and copper or copper alloy particles is produced in a desired ratio. In one embodiment, the desired ratio comprises 10% to 40% copper or copper alloy.

At block 62, thermo polyurethane is supplied to the first extruder of the co-extruder in block 60.

At block 63, the mixture of thermo polyurethane and copper or copper alloy particles from block 61 is supplied to the second extruder of the co-extruder in block 60.

At block 64, the co-extruder from block 60 constructs the polyurethane jacket with the outer portion containing the copper or copper alloy particles. In one embodiment, the outer portion comprises approximately 10% of a thickness of the jacket.

The biocide coating of the invention prevents settlement of the invertebrate larvae (macro-fouling), algae, and bacteria (micro-fouling) that cause marine growth. Thus, in the system and method of the invention, depositing biocide onto sensor cable jackets, will prevent or reduce invertebrate, algae, and bacteria settlement. Reduction of marine growth on sensor cable jackets will result in several advantages, including the following.

The reduction of marine growth will reduce eddy formation at the surfaces of the sensor cable jackets, bringing about a consequent reduction of noise caused by the turbulent flow. The quieter towing will improve the signal-to-noise ratio, a great benefit in geophysical surveying.

The reduction of marine growth will reduce drag on a towed streamer, allowing the equipment to be towed through the water with higher energy efficiency. This higher efficiency could produce a reduction in fuel costs for the same survey configuration. Alternatively, the higher efficiency could allow greater towing capacity (such as an increase in the number of streamers, the length of each streamer, or the towing spread) at the current fuel costs and towing power of the seismic vessel.

The reduction of marine growth will reduce production time lost to cleaning or replacing sensor cable jackets. This will also reduce work boat and cleaning equipment exposure hours for the crew. The reduction of marine growth will reduce the wear and extend the operational life of the sensor cable jackets.

In the system and method of the invention, biocide density is adjusted to produce a protective coating that provides the advantages discussed above and, at the same time, is suitable for the seismic or electromagnetic cable application. In particular, a copper or copper alloy coating should not be so thick or contain so much copper as to interfere with the acoustic properties of sensors in the streamers, such as hydrophones and geophones, or the properties of electromagnetic sensors.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A marine sensor cable, comprising:
a jacket covering an exterior of the sensor cable;
wherein the jacket comprises an outer portion containing biocide disposed in a co-extrusion process.

2. The marine sensor cable of claim 1, wherein the jacket comprises polyurethane.

3. The marine sensor cable of claim 2, wherein the outer portion comprises a mixture of thermal polyurethane and biocide.

4. The marine sensor cable of claim 3, wherein the outer portion comprises approximately 10% of a thickness of the jacket.

5. The marine sensor cable of claim 3, wherein biocide comprises copper or copper alloy particles.

6. The marine sensor cable of claim 5, wherein the mixture comprises 10% to 40% copper or copper alloy particles.

7. The marine sensor cable of claim 1, wherein the sensor cable comprises a towed seismic streamer.

8. The marine sensor cable of claim 1, wherein the sensor cable comprises an electromagnetic streamer.

9. The marine sensor cable of claim 1, wherein the sensor cable comprises an ocean bottom cable.

10. A method for producing a marine sensor cable jacket with anti-fouling properties, comprising:
providing a co-extruder to construct a polyurethane jacket for a sensor cable with a first extruder constructing an inner portion of the jacket and a second extruder constructing an outer portion of the jacket;
producing a mixture of thermo polyurethane and biocide;
supplying thermo polyurethane to the first extruder;
supplying the mixture of thermo polyurethane and biocide to the second extruder; and
constructing the polyurethane jacket with the outer portion containing the biocide.

11. The method of claim 10, wherein biocide comprises copper or copper alloy particles.
